(19) United States
(12) Patent Application Publication
(10) Pub. No.: US 2006/0122840 A1
(43) Pub. Date: Jun. 8, 2006

(54) Tailoring communication from interactive speech enabled and multimodal services

(76) Inventors: David Anderson, Lawrenceville, GA (US); Senis Busayapongchai, Tucker, GA (US); Barrett Kreiner, Norcross, GA (US)

Correspondence Address: Merchant & Gould P.C., P.O. Box 2903, Minneapolis, MN, 55402-0903, US

(21) Appl. No.: 11/005,824

(22) Filed: Dec. 7, 2004

(51) Int. Cl. G10L 21/00

(52) U.S. Cl. 704/275

(57) ABSTRACT

Methods, computer program products, and systems that tailor communication of an interactive speech and multimodal services system are provided. An automated application provides intelligence that customizes speech and/or multimodal services for a user. A method involves utilizing designated communication characteristics to interact with a user of the interactive speech and/or multimodal services system. The interaction may take place via a synthesis device and/or a visual interface. Designated communication characteristics may include a tempo, a dialect, an animation, content and an accent of prompts, filler, and/or information provided by the speech and multimodal system. The method further involves monitoring communication characteristics of the user, altering the designated communication characteristics to match and/or accommodate the communication characteristics of the user, and providing information to the user utilizing the altered characteristics of the communication.

### TECHNICAL FIELD

The present invention relates in general to speech and audio recognition and, more particularly, to tailoring or customizing interactive speech and/or interactive multimodal applications for use in automated assistance services systems.

### BACKGROUND

Many individuals have had the experience of interacting with automated speech-enabled assistance services. Previous speech synthesis systems can output text files in an intelligible, but somewhat dull voice, however, they cannot imitate the full spectrum of human cadences and intonations. Generally, previous speech enabled applications are built for the masses and deliver the same experience to each user. These previous systems leave much to be desired for the individual wanting more of a responsive, efficient, and personable encounter. For example, common complaints are that the time for speech-enabled services to announce menu items is too long or that submenus are unresponsive and impersonal traps that leave users searching for a way to speak with a human. Some previous systems have made efforts to provide users with options that are specific to their needs or preferences, such as featured menu items based on a user's subscribed to services. However, the challenge is to make interactions between man and machine more human, personable, efficient and helpful thereby leaving the user satisfied instead of frustrated with the interactive experience.

### SUMMARY

Embodiments of the present invention address these issues and others by providing methods, computer program products, and systems that tailor communication, for example prompts, filler, and/or information content from an interactive speech and multimodal services system. The present invention may be implemented as an automated application providing intelligence that customizes speech and/or multimodal services for the user.

One embodiment is a method of tailoring communication from an interactive speech and multimodal service to a user. The method involves utilizing designated characteristics of the communication to interact with a user of the interactive speech and multimodal services system. The interaction may take place via a synthesis device and/or a visual interface. Designated communication characteristics may include a tempo, an intonation, an intonation pattern, a dialect, an animation, content, and an accent of the prompts, the filler, and/or the information. The method further involves monitoring communication characteristics of the user, altering the designated characteristics of the communication to match and/or accommodate the communication characteristics of the user, and providing information to the user utilizing the tailored characteristics of the communication from the speech and multimodal services system.

Another embodiment is a computer program product comprising a computer-readable medium having control logic stored therein for causing a computer to tailor communication of an interactive speech and a multimodal services system. The control logic includes computer-readable program code for causing the computer to utilize a tempo, intonation, intonation pattern, dialect, content and/or an accent of the communication to interact with a user of the interactive speech and the multimodal services system. The control logic further includes computer-readable program code for causing the computer to monitor a tempo, intonation, intonation pattern, dialect, and/or accent of a voice of the user and alter the tempo, the intonation, the intonation pattern, the dialect, the content, and/or the accent of the communication to match and/or accommodate the tempo, the intonation, the intonation pattern, the dialect, and/or the accent of the voice of the user. Still further, the control logic includes computer readable program code for causing the computer to provide information to the user utilizing the altered tempo, intonation, intonation pattern, dialect, content and/or accent of the communication.

Still another embodiment is an interactive speech and multimodal services system for tailoring communication utilized to interact with one or more users of the system. The system includes a voice synthesis system that utilizes a tempo, intonation, intonation pattern, dialect, content, and accent of the communication to interact with the user of the interactive speech and multimodal services system. The system also includes a computer-implemented application that provides the communication, such as prompts, filler, and/or information content, to the voice synthesis system, monitors a tempo, an intonation, an intonation pattern, a dialect, and/or an accent of a voice of the user, and alters the tempo, the intonation, the intonation pattern, the dialect, the content, and/or the accent of the communication to match and/or accommodate the tempo, the intonation, the intonation pattern, the dialect, and the accent of the voice of the user.

### BRIEF DESCRIPTION OF THE DRAWINGS

FIG. 1 shows one illustrative embodiment of an encompassing communications network interconnecting verbal, visual, and multimodal communications devices of the user with the network-based interactive speech and multimodal services system that automates tailoring of the communication from the interactive speech and multimodal services system to the user; and

FIGS. 2a-2b illustrate one set of logical operations that may be performed within the communications network of FIG. 1 to tailor the communication from the speech and multimodal services system to a user.

### DETAILED DESCRIPTION

As described briefly above, embodiments of the present invention provide methods, systems, and computer-readable mediums for tailoring communication, for example prompts, filler, and/or information content, of an interactive speech and/or multimodal services system. In the following detailed description, references are made to accompanying drawings that form a part hereof, and in which are shown by way of illustration specific embodiments or examples. These illustrative embodiments may be combined, other embodiments may be utilized, and structural changes may be made without departing from the spirit and scope of the present invention. The following detailed description is, therefore, not to be taken in a limiting sense, and the scope of the present invention is defined by the appended claims and their equivalents.

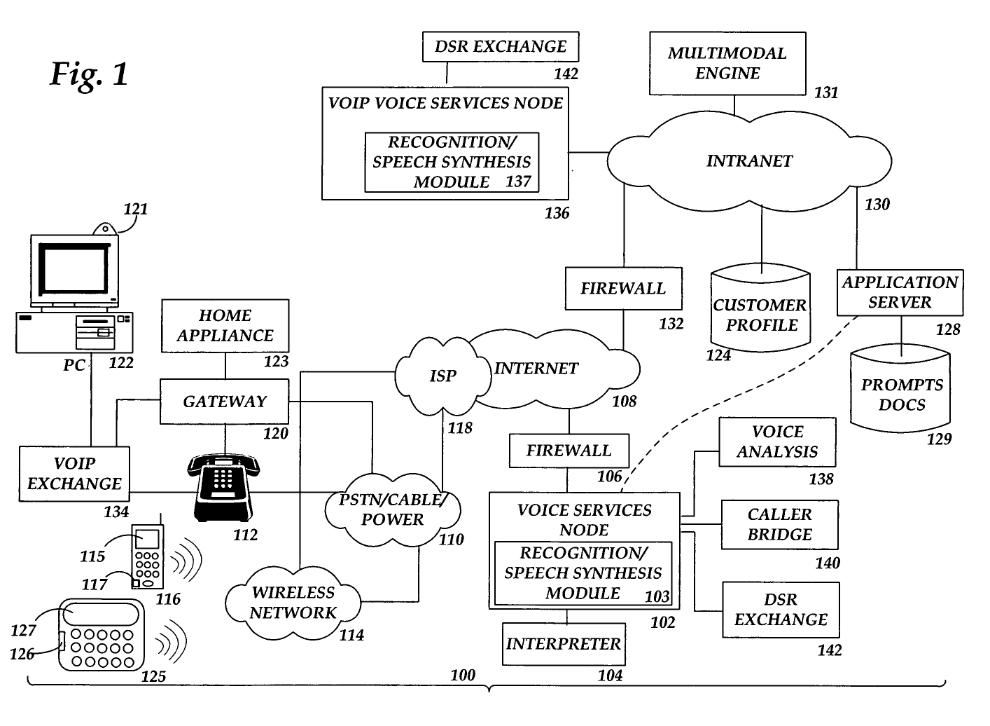

Referring now to the drawings, in which like numerals represent like elements through the several figures, aspects of the present invention and the illustrative operating environment will be described. FIG. 1 and the following discussion are intended to provide a brief, general description of a suitable environment in which the embodiments of the invention may be implemented. While the invention will be described in the general context of program modules that execute in conjunction with a BIOS program that executes on a personal or server computer in a communications network environment, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the present invention provide verbal and visual interaction with a user of the interactive speech and multimodal services. For example, a personal computer may implement the assistive services and the verbal and visual interaction with the user. As another example, a pocket PC working in conjunction with a network-based service may implement the verbal and visual interaction with the user. As another example, an entirely network-based service may implement the visual and verbal interaction with the user. The automated interactive speech and multimodal services system allows one or more users to interact with assistive services by verbally and/or visually communicating with the speech and multimodal system. Verbal communication is provided from the speech and multimodal system back to the individual, and visual information may be provided as well when the user accesses or receives the automated speech and multimodal services through a device supporting visual displays. Accordingly, the assistive services may be accessed and/or received by using the PC or by accessing the network-based assistive services with a telephone, PDA, or a pocket PC.

FIG. 1 illustrates one example of an encompassing communications network 100 interconnecting verbal and/or visual communications devices of the user with the network-based interactive speech and multimodal services system that automates tailoring the prompts, filler, and/or content of the system for a user. The user may interact with the network-based speech and multimodal services system through several different channels of verbal and visual communication. As discussed below, the user communicates verbally with a voice synthesis device and/or a voice services node that may be present in one of several locations of the different embodiments.

As one example of the various ways in which the automated speech and multimodal services system may interact with a user, the user may place a conventional voice call from a telephone 112 through a network 110 for carrying conventional telephone calls such as a public switched telephone network (“PSTN”) or an adapted cable television or power-grid network. The call terminates at a terminating voice services node 102 of the PSTN/cable network 110 according to the number dialed by the customer. This voice services node 102 is a common terminating point within an advanced intelligent network (“AIN”) of modern PSTNs and adapted cable or power networks and is typically implemented as a soft switch, feature server and media server combination.

Another example of accessing the system is by the user placing a voice and/or visual call from a wireless phone 116 equipped with a display 115 and a camera and a motion detector 117 for recognizing and displaying an avatar matching the animation of a user. The wireless phone 116 maintains a wireless connection to a wireless network 114 that includes base stations and switching centers as well as a gateway to the PSTN/cable network 110. The PSTN/cable/power network 110 then directs the call from the wireless phone 116 to the voice services node 102 according to the number or code dialed by the user on the wireless phone 116. Furthermore, the wireless phone 116 or a personal data device 125, such as a personal digital assistant equipped with a camera and motion detector 126 and a display 127, may function as a voice and/or visual client device. The personal data device 125 or the wireless phone 116 function relative to the verbal and/or visual functions of the automated speech and multimodal services system such that the visual and/or voice client device implements a distributed speech recognition (“DSR”) process to minimize the information transmitted through the wireless connection. The DSR process takes the verbal communication received from the user at the visual and/or voice client device and generates parameterization data from the verbal communication. The DSR parameterization data for the verbal communication is then sent to the voice service node 102 or 136 rather than all the data representing the verbal communications. The voice services node 102 or 136 then utilizes a DSR exchange function 142 to translate the DSR parameterization data into representative text which the voice services node 102 or 136 can deliver to an application server 128.

Another example of accessing the speech and multimodal services system is by the user placing a voice call from a voice-over-IP (“VoIP”) based device such as a personal computer (PC) 122 equipped with a video camera 121, or where telephone 112 is a VoIP phone. This VoIP call from the user may be to a local VoIP exchange 134 which converts the VoIP communications from the user's device into conventional telephone signals that are passed to the PSTN/cable network 110 and on to the voice services node 102. The VoIP exchange 134 converts the conventional telephone signals from the PSTN/cable network 110 to VoIP packet data that is then distributed to the telephone 112 as a VoIP phone or the PC 122 where it becomes verbal information to the customer or user. Furthermore, the wireless phone 116 may be VoIP capable such that communications with the wireless data network 114 occur over VoIP and are converted to speech prior to delivery to the voice services node 102.

The VoIP call from the user may alternatively be through an Internet gateway 120 of the customer, such as a broadband connection or wireless data network 114, to an Internet Service Provider (“ISP”) 118. The ISP 118 interconnects the gateway 120 of the customer or wireless network 114 to the Internet 108 which then directs the VoIP call according to the number dialed, which signifies an Internet address of a voice services node 136 of an intranet 130 from which the speech and multimodal services are provided. This intranet 130 is typically protected from the Internet 108 by a firewall 132. The voice service node 136 includes a VoIP interface and is typically implemented as a media gateway and server which performs the VoIP-voice conversion such as that performed by the VoIP exchange 134 but also performs text-to-speech, speech recognition, and natural language understanding such as that performed by the voice services node 102 and discussed below. Accordingly, the discussion of the functions of the voice services node 102 also applies to the functions of the voice service node 136.

A multimodal engine 131 includes a server side interface to the multimodal client devices such as the personal data device 125, the PC 122 and/or the wireless device 116. The multimodal engine 131 manages the visual side of the service and mediates the voice content via an interface to the voice service nodes 102 or 136 containing the recognition/speech synthesis service modules 103 or 137. For instance, when using VoIP, Session Initiated Protocol (SIP), or Real-Time Transport Protocol (RTP) positioned in front of the VoIP Service Node 136 (or if in a TDM/PSTN environment, the Voice Service Node/Interpreter 102/104), the multimodal engine 131 will manage the context of the recognition/speech synthesis service. Thus, the multimodal engine 131 will thereby govern the simultaneous and/or concurrent voice, visual and tailored communication exchanged between client and server.

The multimodal engine 131 may automatically detect a user's profile or determine user information when a user registers. The multimodal engine 131 serves as a mediator between a multimodal application and a speech application hosted on the application server 128. Depending on the user's device identification (IP or TDM CLID) and stored content in the user profile, user information can be automatically populated in the recognition/speech synthesis service.

As yet another example, the wireless device 116, personal digital assistant 125, and/or PC 122 may have a wi-fi wireless data connection to the gateway 120 or directly to the wireless network 114 such that the verbal communication received from the customer is encoded in data communications between the wi-fi device of the customer and the gateway 120 or wireless network 114.

Another example of accessing the voice services node 102 or VoIP services node 136 is through verbal interaction with an interactive home appliance 123. Such interactive home appliances may maintain connections to a local network of the customer as provided through the gateway 120 and may have access to outbound networks, including the PSTN/cable network 110 and/or the Internet 108. Thus, the verbal communication may be received at the home appliance 123 and then channeled via VoIP through the Internet 108 to the voice services node 136 or may be channeled via the PSTN/cable network 110 to the voice services node 102.

Yet another example provides for the voice services node 102, with or without the multimodal engine 131, to be implemented in the gateway 120 or other local device of the customer so that the voice call with the customer is directly with the voice services node within the customer's local network rather than passing through the Internet 108 or PSTN/cable network 110. The data created by the voice services node from the verbal communication from the customer is then passed through the communications network 100, such as via a broadband connection through the PSTN/cable network 110 and to the ISP 118 and Internet 108 and then on to the application server 128. Likewise, the data representing the verbal communication to be provided to the customer is provided over the communications network 100 back to the voice services node within the customer's local network where it is then converted into verbal communication provided to the customer or user.

Where the user places a voice call to the network-based service through the voice services node 102, such as when using a telephone to place the call for an entirely network based implementation of the speech and multimodal services or when contacting the voice services node 102 through a voice client, the voice services node 102 provides the text-to-speech conversions to provide verbal communication to the user over the voice call and performs speech recognition and natural language understanding to receive verbal communication from the user. Accordingly, the user may carry on a natural language conversation with the voice services node 102. To perform these conversations, the voice services node 102 implements a platform deploying the well-known voice extensible markup language such as “VoiceXML” context, which utilizes a VoiceXML interpreter 104 in the voice services node 102 in conjunction with VoiceXML application documents. Another well-known platform that may be used is the speech application language tags (“SALT”) platform. The interpreter 104 operates upon the VoiceXML or SALT documents to produce verbal communication of a conversation. The interpreter 104 with appropriate application input from the voice services node 102 (or 136), and application server 128, mediates the tailored communications to match the tempo, intonation, intonation pattern, accent, and dialect of the voice of the user. The VoiceXML or SALT document provides the content to be spoken from the voice services node 102. The VoiceXML or SALT document is received by the VoiceXML or SALT interpreter 104 through a data network connection of the communications network 100 in response to a voice call being established with the user at the voice services node 102. This data network connection as shown in the illustrative system of FIG. 1 includes a link through a firewall 106 to the Internet 108 and on through the firewall 132 to the intranet 130.

The verbal communication from the user that is received at the voice services node 102 is analyzed to detect the tempo, accent, and/or dialect of the users voice and is converted into data representing each of the spoken words and their meanings through a conventional speech recognition function of the voice services node 102. The VoiceXML or SALT document that the VoiceXML or SALT interpreter 104 is operating upon sets forth a timing of when verbal information that has been received and converted to data is packaged in a particular request back to the VoiceXML or SALT document application server 128 over the data network. This timing provided by the VoiceXML or SALT document allows the verbal responses of the customer to be matched with the verbal questions and responses of the VoiceXML or SALT document. Matching the communication of the customer to the communication from the voice services node 102 enables the application server 128 of the intranet 130 to properly act upon the verbal communication from the user. This matching also includes matching the tempo, accent, and dialect of the communication from the voice services node 102 to the tempo, accent, and dialect of the communication from the customer. As shown, the application server 128 may interact with the voice services node 102 through the intranet 130, through the Internet 108, or through a more direct network data connection as indicated by the dashed line.

The voice services node 102 may include additional functionality for the network-based speech and multimodal services so that multiple users may interact with the same service. To distinguish the varied voices over a common voice channel to the voice services node 102, the voice services node 102 may include a voice analysis application 138. The voice analysis application 138 employs a voice verification system such as the SpeechSecure™ application from SpeechWorks Division of ScanSoft Inc. Each user may be prompted to register his or her voice with the voice analysis application 138 where the vocal pattern of the user is parameterized for later comparison. This voice registration may be saved as profile data in a customer profile database 124 for subsequent use. During the verbal exchanges the various voice registrations that have been saved are compared with the received voice to determine which user is providing the instruction. The identity of the user providing the instruction is provided to the application server 128 so that the instruction can be applied to the speech and multimodal services' tailored communications accordingly.

The multiple users for the same speech and multimodal services may choose to make separate, concurrent calls to the voice services node 102, such as where each user is located separately from the others. In this situation, each caller can be distinguished based on the PSTN line or VoIP connection that the instruction is provided over. For some multi-user speech and multimodal services, it may not be necessary nor desirable for one user on one phone line to hear the instructions provided from the other user, and since they are on separate calls to the voice services node 102, such isolation between callers is provided. However, the speech and/or multimodal services may dictate or the users may desire that each user hear the instruction provided by the other users. To provide this capability, the voice services node 102 may provide a caller bridge 140 such as a conventional teleconferencing bridge so that the multiple calls may be bridged together, each caller may be monitored by the voice services node and each caller or a designated caller such as a moderator can listen as appropriate to the verbal instructions of other callers during service implementation.

The application server 128 of the communications system 100 is a computer server that implements an application program to control and tailor the automated and network-based speech and multimodal services for the each user. The application server 128 provides the VoiceXML or SALT documents to the voice services node 102 to bring about the conversation with the user over the voice call through the PSTN/cable network 110 and/or to the voice services node 136 to bring about the conversation with the user over the VoIP Internet call. The application server 128 may additionally or alternatively provide files of pre-recorded verbal prompts to the voice services node 102 where the file is implemented to produce verbal communication. The application server 128 may store the various pre-recorded prompts, grammars, and VoiceXML or SALT documents in a prompts and documents database 129. The application server 128 may also provide instruction to the voice services node 102 (or 136) to play verbal communications stored on the voice services node. The application server 128 also interacts with the customer profile database 124 that stores profile information for each user, such as the particular preferences of the user for various speech and multimodal services or a pre-registered voice pattern.

In addition to providing VoiceXML or SALT documents to the one or more voice services nodes 102 of the communications system 100, the application server 128 may also serve hyper-text markup language (“HTML”), wireless application protocol (“WAP”), or other distributed document formats depending upon the manner in which the application server 128 has been accessed. For example, a user may choose to send the application server 128 profile information by accessing a web page provided by the application server 128 to the personal computer 122 through HTML or to the wireless device 116 through WAP via a data connection between the wireless network 114 and the ISP 118. Such HTML or WAP pages may provide a template for entering information where the template asks a question and provides an entry field for the customer to enter the answer that will be stored in the profile database 124.

The profile database 124 may contain many categories of information for a user. For example, the profile database 124 may contain communication settings for tempo, accent, and/or dialect of the customer's voice for interaction with speech and multimodal services. As shown in FIG. 1, the profile database 124 may reside on the intranet 130 for the network-based speech and multimodal services. However, the profile database 124 may contain information that the user considers to be sensitive, such as credit account information. Accordingly, an alternative is to provide the customer profile database at the user's residence or place of business so that the user feels that the profile data is more secure and is within the control of the user. In this case, the application server 128 maintains an address of the customer profile database at the user's local network rather than maintaining an address of the customer profile database 124 of the intranet 130 so that it can access the profile data as necessary.

For the personal data device 125 or personal computer 122 of FIG. 1, the network-based speech and multimodal services may be implemented with these devices acting as a client. Accordingly, the user may access the network-based system through the personal data device 125 or personal computer 122 while the devices provide for the exchange of verbal and/or visual communication with the user. Furthermore, these devices may perform as a client to render displays on a display screen of these devices to give a visual component. Such display data may be provided to these devices over the data network from the application server 128.

Also, for the personal data device 125 or personal computer 122 of FIG. 1, the speech and multimodal services may be implemented locally with these devices acting as a client. Accordingly, the user accesses the speech and multimodal services system directly on these devices and the assistive service itself is implemented on these devices as opposed to being implemented on the application server 128 across the communications network 100. However, the verbal exchange may occur between these devices and the user locally, or the text to speech and speech recognition functions may be performed on the network such that these devices are also clients.

Because the functions necessary for carrying on the speech and multimodal services are integrated into the functionality of the personal data device 125 or personal computer 122 where the devices implement the speech and multimodal services locally, network communications are not necessary for the speech and multimodal services to proceed. However, these device clients may receive updates to the speech and multimodal services application data over the communications network 100 from the application server 128, and multi-user services may require a network connection where the multiple users are located remotely from one another. Updates may include new services to be offered on the device or improvements added to an existing service. The updates may be automatically initiated by the devices periodically querying the application server 128 for updates or by the application server 128 periodically pushing updates to the devices or notification to a subscriber's email or other point of contact. Alternatively or consequently, the updates may be initiated by a selection from the user at the device to be updated.

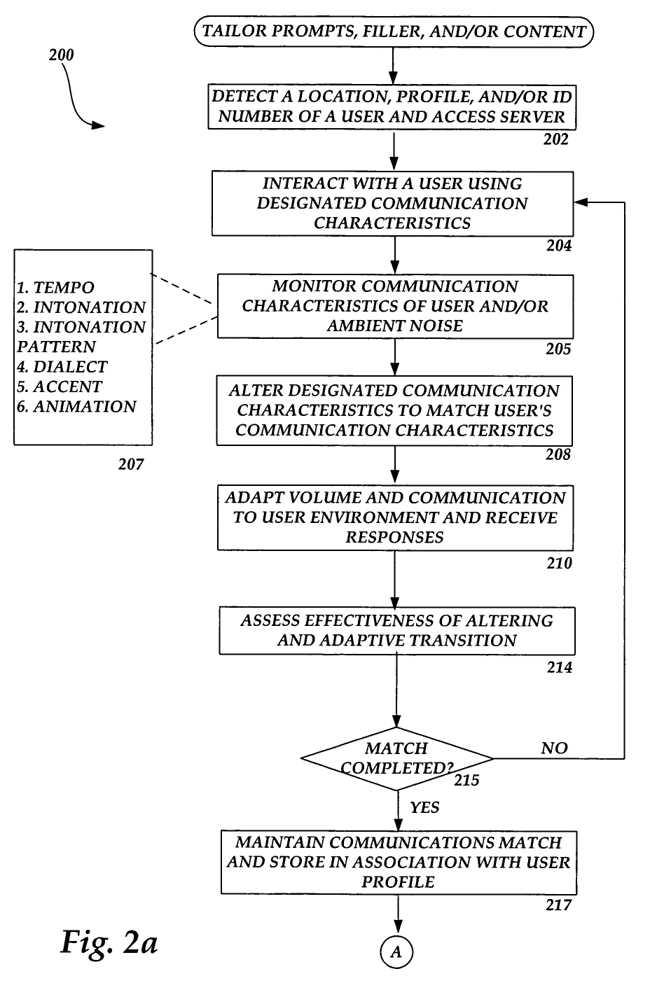

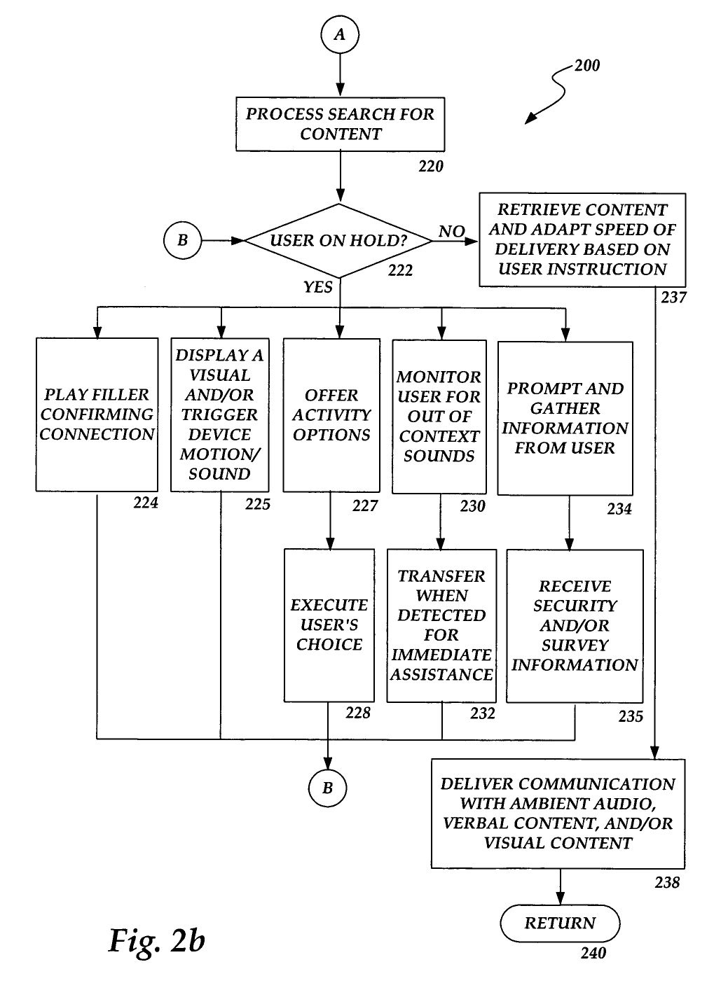

FIGS. 2a-2b illustrate one example of logical operations that may be performed within the communications system 100 of FIG. 1 to tailor the communication, such as prompts, filler, and/or information content, of the speech and multimodal services system to a user. This set of logical operations presented as operational flow 200 is provided for purposes of illustration and is not intended to be limiting. For example, the logical operations of FIG. 2 discuss the application of VoiceXML within the communications system 100. However, it will be appreciated that alternative platforms for distributed text-to-speech and speech recognition may be used in place of VoiceXML, such as SALT discussed above or a proprietary less open method.

The logical operations begin at detect operation 202 where the voice services node 102 (or the application server 128) receives a voice call, directly or through a voice client, such as by dialing the number for the speech and multimodal services for the voice services node 102 on the communications network or by selecting an icon on the personal computer 122 where the voice call is placed through the computer 122. The voice services node 102 detects a location, a profile, and/or an identification number of the caller or user. For example, a landline service address of the phone number provides a location of the user. Also, the cellular phone companies know where a user is located within a few hundred feet because of the cellular phone.

Likewise, the location of a computer can be detected from a network address. Further, when the network is an 802.11 and there is a good location on the wireless node, the location of a user can be generally detected.

The voice services node 102 also accesses the appropriate application server 128 for the network-based speech and multimodal service according to the voice call (i.e., according to the application related to the number dialed, icon selected, or other indicator provided by the customer). Utilizing the dialed number or other indicator of the voice call to distinguish one application server from another allows a single voice services node 102 to accommodate multiple verbal communication services simultaneously. Providing a different identifier for each of the services or versions of a service offered through the voice services node 102 or voice client allows access to the proper application server 128 for the incoming voice calls. Additionally, the voice services node 102 or voice client may receive the caller identification information so that the profile for the user or customer placing the call may be obtained from the database 124 without requiring the user to verbally identify himself. Alternatively, the caller may be prompted to verbally identify herself so that the profile data can be accessed.

At interact operation 204, upon the voice services node 102 or voice client accessing the application server 128, the application server 128 provides introduction/options data through a VoiceXML document back to the voice services node 102. Upon receiving the VoiceXML document with the data, the voice services node 102 or voice client converts the VoiceXML data into verbal information that is provided to the user. This verbal information may provide further introduction and guidance to the user about using the service. This guidance may inform the user that he or she can barge in at any time with a question or with an instruction for the service. The guidance may also specifically ask that the user provide a verbal command, such as a request to start a speech and multimodal service, a request to update the service or profile data, or a request retrieve information from data records. This guidance is communicated to user using designated communication characteristics such as tempo, accent, and/or dialect. It should be appreciated that when an avatar is utilized to interact with the user, guidance may be communicated to the user using a designated animation of the avatar. These designated communication characteristics may be default communication characteristics or set communication characteristics based on a profile of the user.

The voice services node 102 or voice client monitors communication characteristics of the voice of the user as verbal instructions from the user are received at monitor operation 205. This verbal instruction may be a request to search for and retrieve information. As shown in a communication characteristic listing 207, the tempo, intonation, intonation pattern, dialect, and/or accent of the user's voice are monitored. Animation of the user, including facial gestures, may also be monitored by a video feed or motion detector that provides animation data to the multimodal engine 131 where it is processed for meaning. The voice services node 102 or voice client interprets the verbal instructions using speech recognition to produce data representing the words that were spoken. This data is representative of the words spoken by the user that are obtained within a window of time provided by the VoiceXML document for receiving verbal requests so that the voice services node 102 and application server 128 can determine from keywords of the instruction data what the customer wants the service to do. The instruction data is transferred from the voice services node 102 over the data network to the application server 128. Additionally, the ambient noise in the environment of the user may be monitored as part of the monitor operation 205.

Next at adapt operation 208, the voice services node 102 and the application server 128 alter the designated or default communication characteristics to match the communication characteristics of the user. This is a gradual process that may require multiple iterations. Service output will adapt to the caller's spoken input through the speech recognition process. Specific qualities of the voice, its tempo, the pronunciation of specific words and the use of specific words per service context will alert the service hosted on the voice service node 102 and application server 128 to the appropriate matching accent. Indicators in the active speech technology's Acoustic Model combined with the active vocabulary and grammar will provide the required intelligence. Subsequent calls from the caller will mediate the deducted accent and tempo from past calls with the detected tempo and accent of the current call.

For example, if the user has a strong New York accent and speaks at a fast tempo, the speech and multimodal system will match the accent and tempo of the voice of the user from New York. Also, when the user has out of the ordinary facial gestures as they speak, the voice services node 102, the multimodal engine 131, and the server application 128 will detect the motion and match the motion in communication via an avatar displayed via a display screen of a communication device, such as the displays 115 or 127. Further, when the user's facial emotion is detected, the voiced output will be modified to respond to the detected caller emotion such as injecting scripted or dynamically generated statements to calm the caller or to advise them of an alternative action such as a transfer to a customer service representative for help. Also, the adapted scripting is combined with an accommodating expression on the avatar to further serve the caller.

At adapt operation 210, the voice services node 102 adapts the volume of communication from the system and specific prompts, filler, and/or information content to address what has been monitored as ambient noise at the monitor operation 205. For example, when the voice services node 102 detects that the user is in a noisy environment, the voice services node 102 may increase output volume accordingly and respond to the noise with specific prompts. If the noisy environment included a crying child, the voice services node 102 may ask the user if he or she would like the system to hold while they attend to their child or provide an empathetic statement. Another example is when the detected ambient noise indicates a sports game or other excessive ambient noise, the voice services node 102 adapts the prompts to inquire whether additional information is desired such as a radio traffic update related to the sports game.

Still further, another example is when the ambient noise includes sounds associated with a party and/or a bar, the voice services node 102 may adapt the Speech Recognition Technology to better understand the spoken input of the caller and adapt the speed and volume of the scripted output. The voice services node 102 may also be tasked with judging the sobriety of the caller and/or the caller's degree of stress. For example, the service may assess the number of alcoholic drinks consumed by recognizing the communication characteristics of the caller such as slurred speech. The voice services node 102 may then determine whether the degree of slurred speech is associated with sobriety or inebriation. It should be appreciated that the adapted communication is delivered to the user utilizing the tempo, the intonation, the intonation pattern, the dialect, the accent, and/or the content altered at adapt operation 208. The voice services node 102 may also adapt communication based on the profile of the user, the identification number of the user, and/or the location of the user detected at detect operation 202 described above.

Continuing at assess operation 214, the voice services node 102 assesses the effectiveness of altering the designated communication characteristics. The voice services node 102 assesses effectiveness by confirming and/or recognizing communication from the user, determining whether a percentage of recognizing communication from the user has increased, and determining whether a percentage of confirming and/or re-prompting communication has decreased. Altering the designated communication characteristics to match the communication characteristics of the user is assessed to be effective when the percentage of recognizing the communication of the user has increased and the percentage of confirming and/or re-prompting communication to the user has decreased. Thus, when altering the designated communication characteristics is effective, the user is able to interact with the voice services node 102 in more of a natural manner than initial interactions.

Next, at detect operation 215, a determination is made as to whether the matching of the designated communication characteristics is completed. If additional matching is needed the operational flow 200 returns to interact operation 204 described above. When the matching is completed, operational flow 200 continues to storage operation 217 where the voice services node 102 and application server 128 maintains the communications match and stores in the database 124 the altered designated communication characteristics with related context in association with the profile of the user.

At process operation 220 the voice services node 102 and application server 128 processes search requests received from the user during interaction with the user beginning at operation 204. The operational flow 200 then continues to detect operation 222 where a determination is made as to whether the user has been put on hold while the voice services node 102 and application server 128 processes search requests. If the user is not placed on hold, the operational flow continues to retrieve operation 237 where the voice services node 102 and application server 128 retrieves content associated with the request from the user, adapts a speed of delivering the content to the user based on receiving an unsolicited command associated with the speed from the user, such as “faster” or “slower”. The commands received from a user may be associated with a global navigational grammar that initiates the same functionality with any voice services node 102 or an instructed command such as in “help” that is included in the service. The varied speed of delivering the content may also be based on receiving a solicited confirmation from the user associated with the speed and/or detecting a preset speed designated by the user. The operational flow 200 then continues to delivery operation 238 described below.

When the user is placed on hold, the operational flow 200 continues from detect operation 222 to one or more of the operations 224, 225, 227, 230, and/or 234 described below. At filler operation 224, in response to the user being placed on hold, the voice services node 102 and application server 128 plays filler that confirms to the user a connection still exist. The playing of filler may include playing a coffee percolating sound, a human humming sound, a keyboard typing sound, singing and music, a promotional message, and/or one or more other sounds that simulate human activity.

At visual operation 225, the voice services node 102, multimodal engine 131, and the application server 128 displays a visual to the user, for example emails and/or graphs. The multimodal engine 131 and application server 128 may also trigger motion and/or sound in a communication device of the user. For example, the multimodal engine 131 may send a signal that causes a user's cell phone to vibrate or periodically make a sound. At option operation 227, the voice services node 102, multimodal engine 131 and application server 128 offers activity options to the user. The activity options offered to the user may include a joke of the day, news, music, sports, and/or weather updates, trivia questions, movie clips, interactive games, and/or a virtual avatar for modifications. Once the user selects an option, the operational flow continues from option operation 227 to execute operation 228 where the voice services node 102, multimodal engine 131 and application server 128 executes the user's selected option. It should be appreciated that the interactive games offered might be implemented as described in copending U.S. utility patent application entitled “Methods and Systems for Establishing Games with Automation Using Verbal Communication“having Ser. No. 10/603,724, filed on Jun. 24, 2003, which is hereby incorporated by reference.

At monitor operation 230, the voice services node 102, multimodal engine 131, and application server 128 monitors the user and the ambient environment of the user for out of context words and/or emotion. In response to detecting out of context words and/or emotion, the voice services node 102, multimodal engine 131 and application server 128 responds to the user utilizing filler that demonstrates out of context concern and transfers the user for immediate assistance at transfer operation 232. For example, if the user were to scream, or yell “help” or “Police”, the voice services node 102, multimodal engine 131 and application server 128 may respond with a concerned comment, an alarmed avatar and/or a transfer to a human for assistance. It should be appreciated that the concerned response to an ambient call for help might be similarly implemented as described in U.S. Pat. No. 6,810,380 entitled “Personal Safety Enhancement for Communication Devices” filed on Mar. 28, 2001, which is hereby incorporated by reference.

At prompting operation 234, the voice services node 102, multimodal engine 131 and application server 128 prompts the user for useful security information and/or survey information while the user waits, such as mother's maiden name or customer satisfaction level with a specific service or prior encounter. Once the user responds, the voice services node 102, multimodal engine 131 and application server 128 receives the user's responses at receive operation 235. As the on-hold operations are being executed with varied audio and/or visual content, the operational flow returns to operation 222 described above to verify hold status.

As briefly described above, the operational flow 200 continues from retrieve operation 237 to delivery operation 238. At delivery operation 238, the voice services node 102, multimodal engine 131 and application server 128 delivers or outputs communication to the user in combination with ambient audio, verbal content and/or visual content. The ambient audio may reflect a perceived preference based on a user profile, a number called, and/or a specific choice of the user. For example, a user calling a church would hear gospel music in the background or calls to a military base would hear patriotic music. The voice services node 102, multimodal engine 131 and application server 128 may also combine designated communication characteristics via a synthesis device and a visual interface to interact with the user. Here, the prompts, filler, and information content that have been gradually altered, including visual content. For example, the voice services node 102, multimodal engine 131 and application server 128 may offer the visual content as a choice to the user and/or deliver the visual content in response to a request of the user. For example, the voice services node 102, multimodal engine 131 and application server 128 may display a list of choices to the user and instead of reading each choice, the voice services node 102, multimodal engine 131 and application server 128 may prompt the user to verbally select a displayed choice.

Thus, the present invention is presently embodied as methods, systems, computer program products or computer readable mediums encoding computer programs for tailoring communication of an interactive speech and/or multimodal services system.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for tailoring communication from an interactive speech and multimodal services system, the method comprising:
utilizing characteristics of the communication to interact with a user of the interactive speech and multimodal services system;
monitoring communication characteristics of the user;
altering the characteristics of the communication to at least one of match and accommodate the communication characteristics of the user; and
delivering the communication utilizing the altered characteristics.

2. The method of claim 1, wherein monitoring the communication characteristics of the user comprises monitoring at least one of a tempo, an intonation, an intonation pattern, a dialect, and an accent of a voice of the user;
wherein altering the characteristics of the communication comprises gradually altering at least one of a tempo, an intonation, an intonation pattern, a dialect, an accent, and content of at least one of prompts, filler, and information from the interactive speech and multimodal services system to at least one of match and accommodate at least one of the tempo, the intonation, the intonation pattern, the dialect, and the accent of the voice of the user; and
wherein delivering the communication utilizing the altered characteristics comprises providing information to the user utilizing at least one of the altered tempo, the altered intonation, the altered intonation pattern, the altered dialect, the altered accent, and the altered content of at least one of the prompts, the filler, and the information.

3. The method of claim 1, further comprising:
assessing an effectiveness of altering the characteristics of the communication; and
storing in association with a profile of the user, the characteristics altered that are assessed to match the communication characteristics of the user.

4. The method of claim 3, wherein assessing the effectiveness of altering the characteristics comprises:
at least one of confirming and recognizing communication from the user;
determining at least one of whether a percentage of recognizing communication from the user has increased and whether a percentage of confirming communication has decreased and whether a percentage of re-prompt communications has decreased; and
when at least one of the percentage of recognizing the communication of the user has increased, the percentage of confirming communications to the user has decreased, and the percentage of re-prompting communications to the user has decreased, assessing that altering the characteristics is effective whereby when altering the characteristics is effective, the user is able to interact with the speech and multimodal services system in a more natural manner than initial interactions.

5. The method of claim 1, further comprising:
determining whether the user is placed on hold; and
in response to the user being placed on hold, at least one of playing a filler that confirms to the user a connection still exist, displaying a visual, triggering at least one of motion and sound in a communication device of the user, offering activity options to the user, monitoring the user for at least one of out of context words, visual actions, and emotion, and gathering information from the user.

6. The method of claim 5, wherein playing the filler comprises at least one of the following:
playing a coffee percolating sound;
playing a human humming sound;
playing a keyboard typing sound;
playing at least one of singing and music;
playing a promotional message; and
playing one or more sounds that simulate human activity;
wherein displaying a visual comprises at least one of displaying emails and displaying out graphs;
wherein triggering motion in the communication device comprises sending a signal causing the communication device to vibrate; and
wherein gathering information comprises prompting the user for at least one of security information and survey information.

7. The method of claim 2, further comprising:
detecting at least one of an ambient noise in an environment of the user, a profile of the user, an identification number of the user, and a location of the user;
adapting at least one of the prompts, the filler, and the information from the interactive speech and multimodal services system based on at least one of the following:
the ambient noise detected in the environment of the user;
the profile of the user;
the identification number of the user; and
the location of the user.

8. The method of claim 1, wherein monitoring the communication characteristics of the user comprises detecting and recognizing an animation of the user via a motion detection device and wherein altering the characteristics comprises at least one of adapting an avatar to match the animation of the user and responding to the animation recognized by transferring the user for human assistance.

9. The method of claim 1, further comprising:
receiving a request for content from the user;
retrieving content associated with the request;
adapting a speed of delivering the content associated with the request to the user based on at least one of the following:
receiving an unsolicited command associated with the speed from the user;
receiving a solicited confirmation from the user associated with the speed;
receiving an unsolicited command from the user associated with the speed as related to a service ‘help’ instruction; and
detecting a preset speed designated by the user.

10. The method of claim 9, wherein receiving an unsolicited command comprises receiving instructions associated with a global navigational grammar.

11. The method of claim 5, wherein offering activity options to the user comprises at least one of the following:
offering a joke of the day;
offering at least one of news, music, sports, and weather;
offering trivia questions;
offering a movie clip;
offering interactive games; and
offering a virtual avatar for modifications.

12. The method of claim 7, wherein adapting at least one of the prompts, the filler, and the information from the interactive speech and multimodal services system based on the ambient noise detected in the environment of the user comprises at least one of the following:
adjusting an output volume of at least one of the prompts, the filler, and the information to accommodate the ambient noise detected;
when the ambient noise includes a crying child, adapting the prompts to empathize concerning the crying child;
when the ambient noise includes a sports game, adapting the prompts to inquire concerning the sports game and offer related information on the sports game; and
when the ambient noise includes sounds associated with at least one of a party and a bar, adapting the prompts to assess a number of alcoholic drinks consumed, further comprising:
assessing the number of alcoholic drinks consumed wherein monitoring the communication characteristics of the user includes:
detecting a degree of slurred speech; and
detecting a degree of stress in the voice of the user; and
determining whether the degree of slurred speech is associated with one of sobriety and inebriation.

13. The method of claim 5, further comprising:
in response to detecting at least one of the out of context words, the visual actions, and the emotion, responding to the user utilizing filler that demonstrates out of context concern; and
transferring the user for immediate assistance.

14. The method of claim 2, further comprising combining ambient audio with at least one of the tempo of, the dialect of, and the accent of at least one of the prompts, the filler, and the content gradually altered wherein the ambient audio reflects at least one of a perceived preference and a specific choice of the user.

15. The method of claim 14, wherein utilizing the designated communication characteristics comprises utilizing the designated communication characteristics via a synthesis device and a visual interface to interact with the user of the interactive speech and multimodal services system and wherein at least one of the prompts, the filler, and the content gradually altered includes visual content, the method further comprising at least one of offering the visual content as a choice to the user and delivering the visual content in response to a request of the user.

16. A computer program product comprising a computer-readable medium having control logic stored therein for causing a computer to tailor communication of an interactive speech and a multimodal services system, the control logic comprising computer readable program means for causing the computer to:
utilize characteristics of the communication via a synthesis device to interact with a user of the interactive speech and the multimodal services system;
monitor communication characteristics of the user;
alter the characteristics of the communication to match the communication characteristics of the user; and
deliver information to the user utilizing the altered characteristics of the communication.

17. The computer program product of claim 16, further comprising computer readable program means for causing the computer to:
at least one of confirm and recognize communication from the user;
determine at least one of whether a percentage of recognizing communication of the user has increased, whether a percentage of confirming communication has decreased, and whether a percentage of re-prompt communications has decreased; and
when at least one of the percentage of recognizing the communication of the user has increased, the percentage of confirming communication of the user has decreased, and the percentage of re-prompt communications has decreased, assess that altering the characteristics of the communication is effective whereby when altering the characteristics of the communication is effective, the user is able to interact with the speech and multimodal services system in a more natural manner than initial interactions.

18. The computer program product of claim 16, further comprising computer readable program means for causing the computer to:
detect and recognize an animation of the user via a motion detection device; and
adapt an avatar of the multimodal services to at least one of match and respond to the animation of the user.

19. An interactive speech and multimodal services system capable of tailoring communication with at least one user, the system comprising:
a voice services node that utilizes at least one of a tempo an intonation, an intonation pattern, a dialect, an accent, and content of the communication to interact with the user of the interactive speech and multimodal services system;
a multimodal engine that interacts with the voice service node and integrates appropriate multimodal content for the communication to interact with the user of the interactive speech and multimodal services system; and
an application server that provides the communication to the voice services node and multimodal engine, monitors at least one of a tempo, an intonation, an intonation pattern, a dialect, and an accent of a voice of the user, and alters at least one of the tempo, the intonation, the intonation pattern, the dialect, the accent, and the content of the communication to at least one of match and accommodate at least one of the tempo, the intonation, the intonation pattern, the dialect, and the accent of the voice of the user.

20. The system of claim 19, further comprising a communications synthesis system comprising:
a communications synthesis device of the user that receives the communication from the application server over a data network, and provides the communication to the user, and
a speech recognition process that receives a response from the user, converts the response into the instruction data, and provides the instruction data to the application server over the data network; and
wherein the interactive speech and multimodal services system further comprises a visual interface that utilizes an animation of the communication to interact with the user wherein the application server further monitors an animation of the user via a motion detection device and alters the animation of the communication to at least one of match and accommodate the animation of the user.

21. The system of claim 20, further comprising:
a distributed speech recognition (DSR) processor embedded within the communications synthesis device, the DSR processor operative to:
receive user communication at the communications synthesis device;
generate parameterization data from the user communication; and
transmit the parameterization data to at least one of the voice services node and the multimodal engine;
whereby data transmitted to the voice services node representing the user communication is reduced; and
wherein the voice services node utilizes a DSR exchange function to translate the parameterization data into representative text which the voice services node can deliver to the application server.

22. The system of claim 20, wherein the user comprising multiple users, further comprising:
a caller bridge operative to bridge multiple calls from the multiple users together; and
a voice analysis application operative to:
detect a tempo, intonation, intonation pattern, dialect, and accent for each voice of the multiple users;
detect an animation for each of the multiple users; and
provide to the application server an identity of each of the multiple users providing an instruction whereby the application server may apply each instruction and tailor the communication from the speech and multimodal services system to each of the multiple users identified.
